(19) United States
(12) Patent Application Publication
(10) Pub. No.: US 2024/0257213 A1
(43) Pub. Date: Aug. 1, 2024

(54) Systems and Methods for Improving Browse Category Rankings on Electronic Platforms with Large-Scale Databases

(71) Applicant: Walmart Apollo, LLC, Bentonville, AR (US)

(72) Inventors: Varun Joshi, Jersey City, NJ (US); Cun Mu, New York, NY (US); Zheng Yan, Short Hills, NJ (US)

(73) Assignee: Walmart Apollo, LLC, Bentonville, AR (US)

(21) Appl. No.: 18/103,283

(22) Filed: Jan. 30, 2023

(51) Int. Cl. G06Q 30/0601; G06Q 30/0201

(52) U.S. Cl. CPC G06Q 30/0631; G06Q 30/0201; G06Q 30/0623

(57) ABSTRACT

Systems and methods including one or more processors and one or more non-transitory storage devices storing computing instructions executed by the one or more processors can perform functions comprising: storing a category classification hierarchy that classifies items into a plurality of browse categories; monitoring user engagement metrics for each of the items; using the user engagement metrics to compute shelf importance signals for the items; executing a ranking engine that generates a ranked item listing for a browse category based, at least in part, on the shelf importance signals for the items; and transmitting the ranked item listing for the browse category to a computing device. Other embodiments are disclosed herein.

### TECHNICAL FIELD

This disclosure relates generally to improved ranking techniques for items displayed in browse categories.

### BACKGROUND

Various electronic platforms can be accessed by computing devices over a network to enable users to browse, view, and/or place orders for items (e.g., products and/or services). Users can search for desired items in various ways. For example, in many cases, an electronic platform can include a search engine that enables users to submit textual search queries to search for desired items. Additionally, users can search for items by selecting browse categories associated with the items. For example, the electronic platform may store a classification hierarchy that associates each item offered by the platform with one or more categories, and users can select options to view items that are associated with each category.

When users select a category to browse items, the items may initially be ranked. The manner in which the items are ranked can be important, and ideally should permit users to rapidly view and access the items in the category that are most likely to be relevant. However, ranking the items in the category in an appropriate manner is technically challenging, especially in scenarios where categories can have large numbers of items (e.g., thousands or millions).

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system according to certain embodiments;

FIG. 4 illustrates a representative block diagram of a portion of the system in FIG. 3 according to certain embodiments;

FIG. 5A illustrates an exemplary category classification hierarchy according to certain embodiments;

FIG. 5B is a table illustrating a first technique for generating and storing shelf importance signals according to certain embodiments;

FIG. 5C is a table illustrating a second technique for generating and storing shelf importance signals according to certain embodiments; and

FIG. 6 is a flow chart illustrating an exemplary method according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and perform functions comprising: storing a category classification hierarchy that classifies items into a plurality of browse categories, the category classification hierarchy comprising a plurality of hierarchy levels and each of the plurality of browse categories is associated with at least one of the hierarchy levels; monitoring user engagement metrics for each of the items; using the user engagement metrics to compute shelf importance signals for the items, each of which predicts or measures an importance of an item with respect to a hierarchy level in the category classification hierarchy; in response to receiving a request from a computing device to view a browse category, executing a ranking engine to generate a ranked item listing for the browse category based, at least in part, on the shelf importance signals for the items; and transmitting the ranked item listing for the browse category to the computing device.

Various embodiments include a method. The method can be implemented via execution of computing instructions configured to run at one or more processors and configured to be stored at non-transitory computer-readable media The method can comprise: storing a category classification hierarchy that classifies items into a plurality of browse categories, the category classification hierarchy comprising a plurality of hierarchy levels and each of the plurality of browse categories is associated with at least one of the hierarchy levels; monitoring user engagement metrics for each of the items; using the user engagement metrics to compute shelf importance signals for the items, each of which predicts or measures an importance of an item with respect to a hierarchy level in the category classification hierarchy; in response to receiving a request from a computing device to view a browse category, executing a ranking engine to generate a ranked item listing for the browse category based, at least in part, on the shelf importance signals for the items; and transmitting the ranked item listing for the browse category to the computing device.

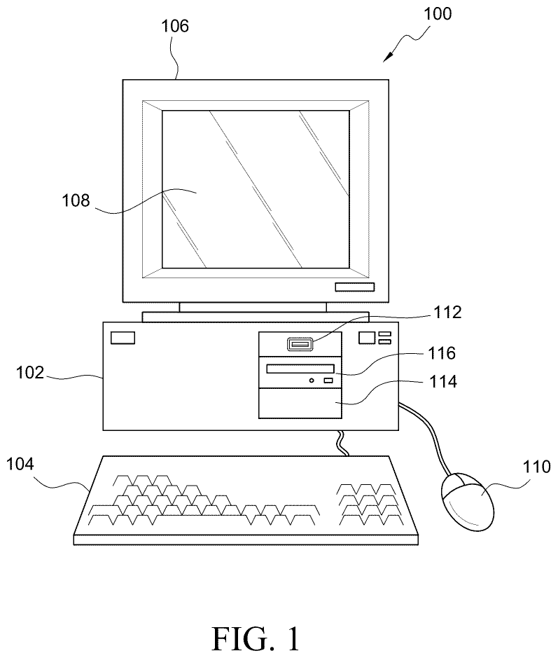

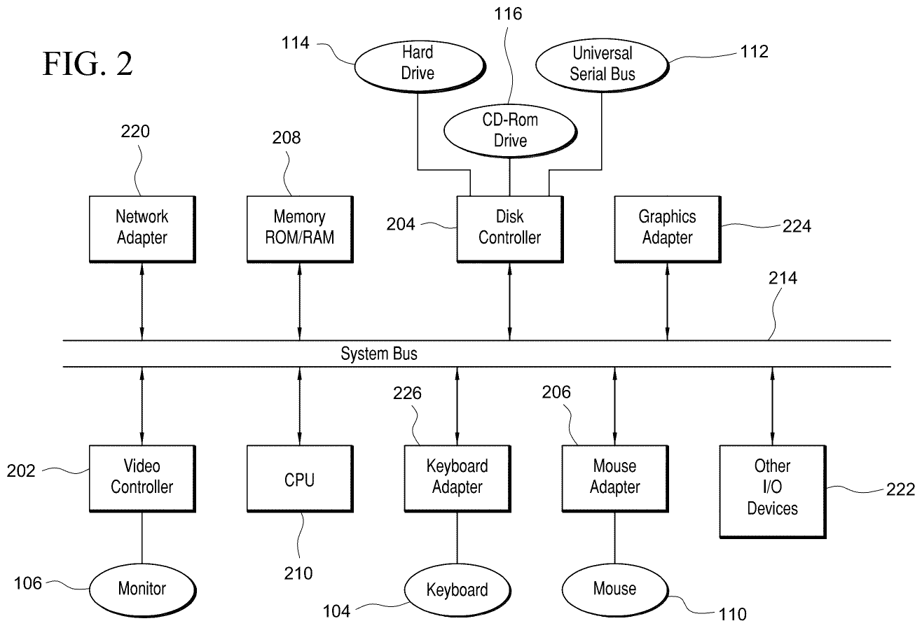

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

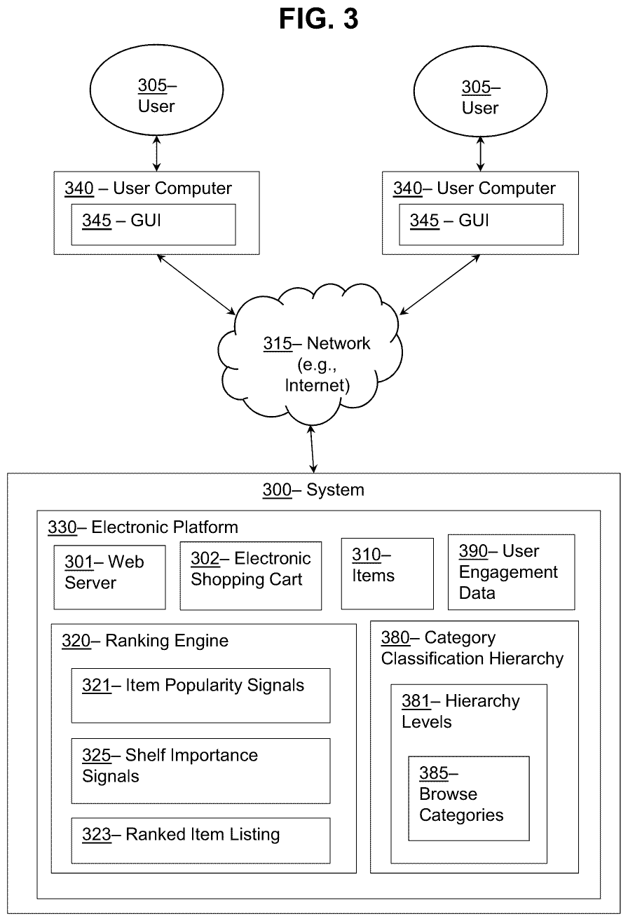

Turning ahead in the drawings, FIG. 3 illustrates a block diagram of a system 300 that can be utilized for ranking or reordering items 310 included in various browse categories 385, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a web server 301, a ranking engine 320, and an electronic platform 330. The web server 301, ranking engine 320, and/or electronic platform 330 can each be a computer system, such as computer system 100 (FIG. 1), as described above, and can each be a single computer, a single server, or a cluster or collection of computers or servers, or a cloud of computers or servers. In another embodiment, a single computer system can host each of two or more of web server 301, ranking engine 320, and/or electronic platform 330. Additional details regarding the web server 301, ranking engine 320, and/or electronic platform 330 are described herein.

In many embodiments, system 300 also can comprise user computers 340. User computers 340 can comprise any of the elements described in relation to computer system 100. In some embodiments, user computers 340 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In many embodiments, system 300 can comprise graphical user interfaces (“GUIs”) 345. In the same or different embodiments, GUIs 345 can be part of and/or displayed by computing devices associated with system 300 and/or user computers 340, which also can be part of system 300. In some embodiments, GUIs 345 can comprise text and/or graphics (images) based user interfaces. In the same or different embodiments, GUIs 345 can comprise a heads up display (“HUD”). When GUIs 345 comprise a HUD, GUIs 345 can be projected onto glass or plastic, displayed in midair as a hologram, or displayed on monitor 106 (FIG. 1). In various embodiments, GUIs 345 can be color or black and white. In many embodiments, GUIs 345 can comprise an application running on a computer system, such as computer system 100, user computers 340, and/or server computer (e.g., one or more server computers that host the electronic platform 330). In the same or different embodiments, GUI 345 can comprise a website accessed through network 315 (e.g., the Internet). In some embodiments, GUI 345 can comprise an eCommerce website. In the same or different embodiments, GUI 345 can be displayed as or on a virtual reality (VR) and/or augmented reality (AR) system or display.

In some embodiments, web server 301 can be in data communication through network 315 (e.g., the Internet) with user computers (e.g., 340). In certain embodiments, the network 315 may represent any type of communication network, e.g., such as one that comprises the Internet, a local area network (e.g., a Wi-Fi network), a personal area network (e.g., a Bluetooth network), a wide area network, an intranet, a cellular network, a television network, and/or other types of networks. In certain embodiments, user computers 340 can be desktop computers, laptop computers, smart phones, tablet devices, and/or other endpoint devices. Web server 301 can host one or more websites. For example, web server 301 can host an eCommerce website that allows users to browse and/or search for products, to add products to an electronic shopping cart, and/or to purchase products, in addition to other suitable activities.

In many embodiments, the web server 301, ranking engine 320, and/or electronic platform 330 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) associated with the web server 301, ranking engine 320, and/or electronic platform 330 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of the web server 301, ranking engine 320, and/or electronic platform 330. In a similar manner, the processing module(s) and the memory storage module(s) can be local and/or remote to each other.

In many embodiments, the web server 301, ranking engine 320, and/or electronic platform 330 can be configured to communicate with one or more user computers 340. In some embodiments, user computers 340 also can be referred to as customer computers. In some embodiments, the web server 301, ranking engine 320, and/or electronic platform 330 can communicate or interface (e.g., interact) with one or more customer computers (such as user computers 340) through a network 315 (e.g., the Internet). Network 315 can be an intranet that is not open to the public. Accordingly, in many embodiments, the web server 301, ranking engine 320, and/or electronic platform 330 (and/or the software used by such systems) can refer to a back end of system 300 operated by an operator and/or administrator of system 300, and user computers 340 (and/or the software used by such systems) can refer to a front end of system 300 used by one or more users 305, respectively. In some embodiments, users 305 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, the web server 301, ranking engine 320, and/or electronic platform 330 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

Meanwhile, communication between web server 301, ranking engine 320, and/or electronic platform 330, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

In certain embodiments, users 305 may operate user computers 340 to browse, view, purchase, and/or order items 310 via the electronic platform 330. For example, the electronic platform 330 may include an eCommerce website that enables users 305 to add items 310 to a digital shopping cart and to purchase the added items 310. The items 310 made available via the electronic platform 330 may generally relate to any type of product and/or service including, but not limited to, products and/or services associated with groceries, household products, entertainment, furniture, apparel, kitchenware, electronics, fashion, appliances, sporting goods, etc. The electronic platform 330 can be configured to monitor, track, and/or store various types of user engagement data 390 relating to interactions of users 305 with the items 310. For example, the user engagement data 390 collected by the electronic platform 130 can indicate, inter alia, how many times each item 310 was selected (e.g., clicked on) by users 305, how many times each item was added to an electronic shopping cart 302, how many times an order was placed for each item 310, and/or other metrics pertaining to users' interactions with the items 310. As discussed below, various metrics can be derived from the user engagement data 390.

Electronic platform 330 can include a search engine that assists users 305 with identifying items 310. The search engine may generally represent any application, program, and/or feature that is configured to search for items 310 included in database and/or online catalog. Users can be presented with GUIs 345 that enable the users to submit search queries to the search engine, and GUIs 345 can present search results corresponding to the search queries. Each of the search results can correspond to an item 310 included in an online catalog associated with the electronic platform. Users 305 can utilize GUIs 345 to view the search results, select items 310 included in the search results and, if desired, to add the items 310 to a digital shopping cart and/or initiate purchasing of the items 310.

Additionally, users 305 can search for items by selecting browse categories 385 (also referred to as “browse shelfs”) associated with the items 210. Each browse category 385 can correspond to a class or grouping of related items 310. Exemplary browse categories 385 can include classes or categories corresponding to groceries, household products, entertainment, furniture, apparel, kitchenware, electronics, fashion, appliances, sporting goods. Various GUIs 345 generated by the electronic platform 330 can provide options (e.g., hyperlinks) corresponding to each of the browse categories 385. Users 305 can select desired browse categories 385 to view items 310 associated the browse categories 385 and, if desired, add the items 310 to a digital shopping cart and/or initiate purchasing of the items 310.

In certain embodiments, the electronic platform 330 can store a category classification hierarchy 380 that defines a tree structure for the browse categories 385 and/or groups the browse categories 380 into a hierarchy. The category classification hierarchy 380 can include a plurality of hierarchy levels 381. For example, higher hierarchy levels 381 can include browse categories 385 that broadly apply to various types of items 310 (e.g., such as a broad category pertaining to electronics), while lower hierarchy levels 381 can include browse categories 385 that are more narrowly focused on particular subsets of items 310 (e.g., computers, mobile phones, television).

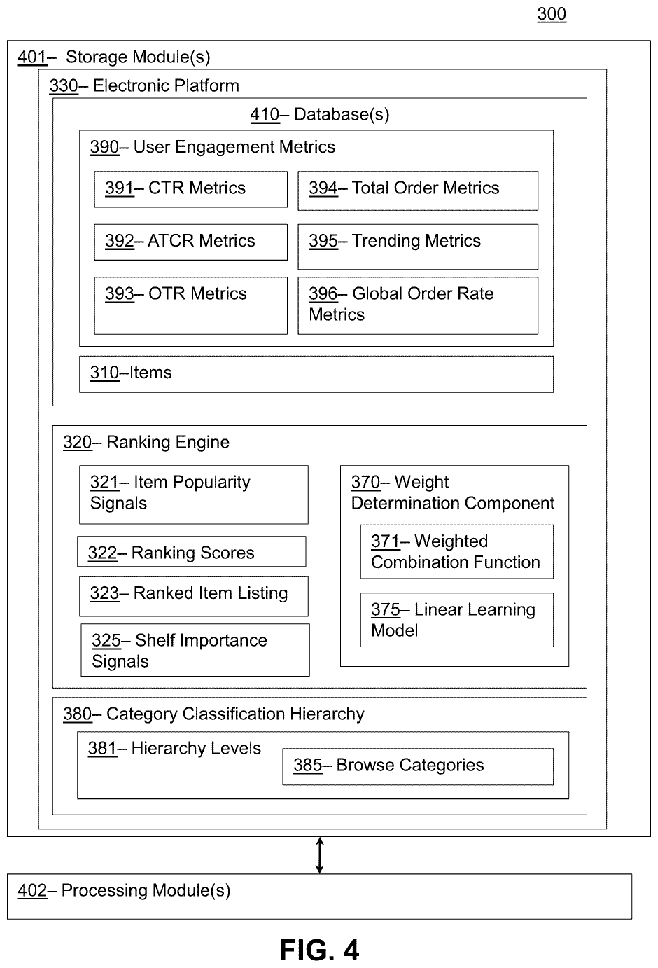

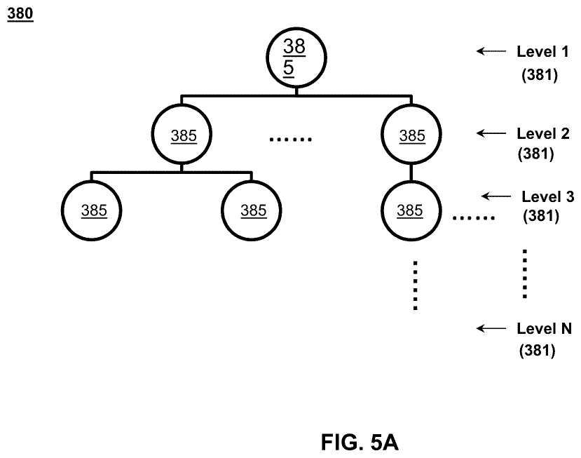

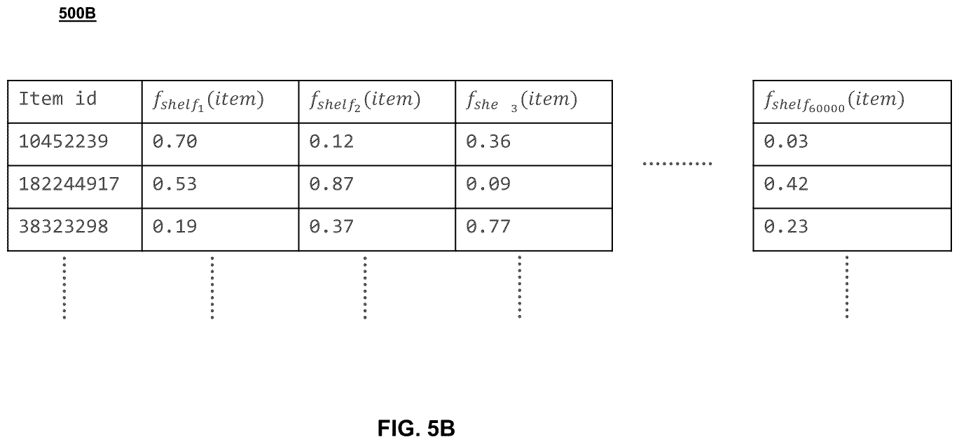

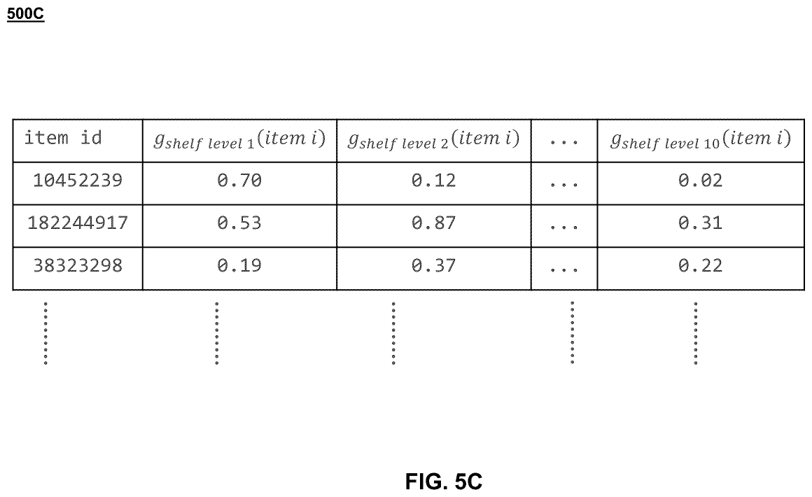

FIG. 5A illustrates an exemplary category classification hierarchy 380 according to certain embodiments. The category classification hierarchy 380 can include any number of hierarchy levels 381, such as levels 1, 2, 3, through N (where N can be any integer). Additionally, any number of browse categories 385 can be included in, or associated with, each of the hierarchy levels 381. In many scenarios, at least one browse category 385 can be included in each hierarchy level 381. Every item 310 (FIGS. 3-4) made available via the electronic platform 330 can be associated with one or more of the browse categories 385.

In a large-scale system, millions of items 310 can be offered via the electronic platform 330 and the category classification hierarchy 380 can include a large number of browse categories (e.g., ˜sixty thousand or a hundred thousand categories). Additionally, large numbers the items 310 can be associated with each browse category (e.g., thousands or millions of items 310 can be associated with each of the browse categories 385). The category classification hierarchy 380 can define a tree structure that organizes or arranges the browse categories 385 from a broad focus in higher hierarchy levels 381 to an increasing narrow focus in each lower hierarchy level 381. In some embodiments, the category classification hierarchy 380 may have ten hierarchy levels 81. In other embodiments, the category classification hierarchy 380 can have a number of hierarchy levels 381 in a range of five through twenty-five. The particular number of hierarchy levels 381 can vary based on how many items and/or how many types of items are being offered by a given electronic platform 330.

In one example, a browse category 385 in a first hierarchy level 381 can correspond to a global product category that encompasses all items made available on the electronic platform. One of the browse categories 385 in a second hierarchy level 381 can correspond to category for electronics, and separate browse categories 385 included in the third hierarchy level 381 can correspond to sub-categories for computers, mobile phones, televisions, and other types of electronics. A fourth hierarchy level 381 can include even more granular categories for each of the aforementioned electronic types. Hence, each level in the hierarchy may include browse categories 385 that correspond to subsets of categories included in a higher level.

Returning to FIG. 3, the electronic platform 330 can provide GUIs 345 that enable users to view the items associated with each of the browse categories. Users can select broad browse categories 385 (e.g., such as one that corresponds to furniture products) and/or more narrowly focused browse categories (e.g., such as one that corresponds to kitchen tables).

Regardless of which browse category 385 is selected by a user, a ranking engine 320 can determine a ranking or ordering of the items 310 included in the browse category to create a ranked item listing, and a GUI 345 can be generated which displays the ranked item listing 323. The manner in which the ranking engine 320 ranks or orders the items included in the ranked item listing 323 for a selected browse category 385 can vary.

One technique for ranking or ordering the items 310 in a browse category 385 can involve the ranking engine 320 using one or more item popularity signals 321 to determine an ordering or ranking of the items 310 in the browse category 385. Generally speaking, the item popularity signals 321 can include various metrics that indicate or measure a popularity of each item 310 based on user engagement data 390. In some embodiments, the item popularity signals 321 may be derived from user engagement data 390 that was collected by the electronic platform 330 in a historical time period and, in some cases, can include metrics indicating a total number of orders placed for each item 310 within a given historical period, metrics indicating whether each of the items are trending in popularity during a most recent time period, and metrics indicating an order rate during a most recent period of time. The item popularity signals 321 can be utilized to order the items 310 included in the browse category 385 from most popular to least popular, and the items 310 can be presented to users 305 based on this ordering.

While utilizing the item popularity signals 321 to determine a ranking or ordering of the items 310 can be useful to some extent, exclusively using the item popularity signals 321 to rank or order the items 310 in a given browse category 385 has certain disadvantages.

A major disadvantage of the aforementioned ranking technique is that it often leads to surfacing items that have an overall high popularity on the electronic platform 330, but which are not particularly popular within the selected browse category 385. For example, a given item 310 corresponding to napkin products can be very popular on the electronic platform 330 (e.g., based on how many times it has been purchased in a historical time period and/or engaged by users in other ways). In some cases, this napkin product can be associated with multiple browse categories 385, one of which corresponds to a broad category for food-related products. Although the overall popularity of the napkin product may be high, the product may be rarely engaged (or less popular) in scenarios where users have selected to view the browse category 385 corresponding to the food-related products. Nonetheless, using the aforementioned ranking technique, the ranking of the napkin product would be promoted based on its overall popularity, and presented towards the beginning of the ranked item listing 323 for the food-related browse category. This is because the item popularity signals 321 do not account for the popularity of the napkin product within the context of the food-related category, but rather accounts for the overall popularity of the product on the electronic platform 330.

To overcome these and other technical challenges, the ranking engine 320 can utilize shelf importance signals 325 (also referred to as “category importance signals”) to assist with ranking or ordering the items in each of the browse categories 385. Generally speaking, a shelf importance signal 325 can include a value that indicates or measures the importance or popularity of a given item 310 in a particular browse category 385. As explained in further detail below, in some cases, the shelf importance signals 325 can indicate the importance of a given item 310 with respect to a hierarchy level 381 in the category classification hierarchy 380 that includes the browse category 385. The shelf importance signals 325 can be utilized by the ranking engine 320 to order or rank items 310 in a manner that considers the importance or popularity of the items 310 in the context of particular browse categories 385.

In certain embodiments, a plurality of shelf importance signals 325 can be computed in an offline, preprocessing operation for each item 310. For each item 310, a separate shelf importance signal 325 can be generated for each hierarchy level 381 included in the category classification hierarchy 380. For example, if a category classification hierarchy 380 includes ten hierarchy levels 381, ten separate shelf importance signal 325 can be generated (one for each hierarchy level 381) for each item 310, and these values can be pre-stored for subsequent retrieval during runtime ranking operations. The description below discloses exemplary techniques for computing or generating the shelf importance signals 325.

During runtime, the ranking engine 320 can retrieve the pre-stored shelf importance signals 325 to determine a ranking or ordering of the items 310 when users select browse categories 385, and the reordered items 310 can be incorporated into a ranked item listing 323 that is presented to the users 305. The ranking engine 320 can utilize the shelf importance signals 325 to order the items in a manner that promotes items 310 that are popular with the context of a particular browse category 38 that has been selected for viewing. Additionally, in some embodiments, usage of the shelf importance signals 325 permits items 310 that were recently added to the electronic platform 330 to have a fair chance of being presented to users 305.

FIG. 4 is a block diagram illustrating a detailed view of a portion of the system 300 in accordance with certain embodiments. The system 300 includes one or more storage modules 401 that are in communication with one or more processing modules 402. The one or more storage modules 401 can include: (i) non-volatile memory, such as, for example, read-only memory (ROM) or programmable read-only memory (PROM); and/or (ii) volatile memory, such as, for example, random access memory (RAM), dynamic RAM (DRAM), static RAM (SRAM), etc. In these or other embodiments, storage modules 401 can comprise (i) non-transitory memory and/or (ii) transitory memory. The one or more processing modules 402 can include one or more central processing units (CPUs), graphical processing units (GPUs), controllers, microprocessors, digital signal processors, and/or computational circuits. The one or more storage modules 401 can store data and instructions associated with providing a ranking engine 320 and electronic platform 330. The one or more processing modules 402 can be configured to execute any and all instructions associated with implementing the functions performed by these components. Exemplary configurations for each of these components are described in further detail below.

The electronic platform 303 can include one or more databases 410 that store items 310 offered on the electronic platform and user engagement data 390 relating to users' interactions with the items 310 on the electronic platform 310. In certain embodiments, various metrics can be derived from the user engagement data 390 for each of the items 310, including:
(1) a click through rate (CTR) metric 391 indicating a percentage of users that selected (e.g., click on) the item 310 when the item 310 was presented or displayed to users in the context of a browse category 385 during a historical time period;
(2) an add-to-cart rate (ATCR) metric 392 indicating a percentage of users that added the item to a digital shopping cart 385 when the item was presented or displayed to users in the context of a browse category 385 during a historical time period; and
(3) an order through rate (OTR) metric 393 indicating a percentage of users that placed an order for the item 310 when the item 310 was presented or displayed to users in the context of a browse category 385 during a historical time period.

The aforementioned metrics can be derived from user interactions that are monitored across the browse categories 385 over a historical period of time (e.g., a previous month or year). In some embodiments, one or more of the above metrics can be utilized to generate or determine the shelf importance signals 325 described herein.

Additional metrics can be derived from the user engagement information 390 to generate the item popularity signals 321. For example, in some cases, the following metrics also may be derived for each of the items:
(1) a total order metric 394 indicating a total or aggregated number of orders placed via the electronic platform for an item during a historical period;
(2) a trending metric 395 that includes a value indicating whether an item is trending in short-term popularity during a recent historical time period; and
(3) a global order rate metric 396 reflecting a percentage of orders placed for item compared to the number of times the item was displayed.

The aforementioned metrics can be determined globally across the electronic platform 330, and some or all of the metrics can be incorporated into the item popularity signals 321 described herein.

Other types of metrics also can be derived from the user engagement data 390 to assist with generating the item popularity signals 321 and the shelf importance signals 325 described herein.

As mentioned above, using only item popularity signals 321 to rank or order the items in a browse category 385 can cause items 310 that are overall popular on the electronic platform 330 to be promoted in the ranked item listing 323 generated by a ranking engine 320, even if those items 310 are not particularly popular within the context of a particular browse category 385. Therefore, the ranking engine 320 can utilize the shelf importance signals 325 to identify and promote items 310 that are popular in the context of the browse categories 385 themselves. The manner in which the shelf importance signals 325 are generated can vary.

One technique for computing the shelf importance signals 325 could be based on a naïve approach that separately computes and indexes a shelf importance signal 325 indicating the importance or popularity of each item 310 for every one of the browse categories 385. During runtime, these stored shelf importance signals 325 can be accessed to determine an ordering or ranking of items 310 in the ranked item list 323 for each browse category 385.

FIG. 5B is an exemplary table 500B illustrating an exemplary naïve approach for computing the shelf importance signals according to certain embodiments. A left column of the table includes a listing of item identifiers corresponding to each of the items made available on the electronic platform. The other columns correspond to browse categories or browse shelfs made available via the electronic platform. In large-scale systems, there may be thousands of browse categories and a separate column could be provided for each. Additionally, as shown, a separate shelf importance signal is computed and stored in the table for each item-browse category pair.

Returning to FIG. 4, the aforementioned native approach to computing the shelf importance signals 325 may not be practical in large-systems which have large quantities of browse categories 385 (e.g., 60k+ browse categories) and thousands or millions of items 310 associated with each of the browse categories 385. Attempting to compute the shelf importance signals 325 for large-scale systems in this manner may require massive amounts of processing resources and could take a very long time (e.g., more than a day).

To address the aforementioned technical challenges, the shelf importance signals 325 for each item 180 can be computed for each hierarchy level 381 (rather than computing the shelf importance signals 325 for each browse category 385). The number of hierarchy levels 381 is significantly lower (e.g., in some cases, may be ten) than the number of browse categories 385, thereby permitting the shelf importance signals 325 to be computed in a computationally feasible manner.

FIG. 5C is an exemplary table 500C illustrating an approach for computing the shelf importance signals on large-scale systems according to certain embodiments. A left column of the table includes a listing of item identifiers corresponding to each of the items made available on the electronic platform. The other columns correspond to hierarchy levels included in a category classification hierarchy for the electronic platform. In some cases, the category classification hierarchy may include ten hierarchy levels (or a number in a range of five to twenty-five) and the table could include a separate column for each level. As shown, a separate shelf importance signal is computed and stored in the table for each item-hierarchy level pair.

When a request to view a browse category is received, the ranking engine 320 can determine which hierarchy level the browse category is associated with, and can retrieve the shelf importance signals from the column associated with the hierarchy level for each item that is associated with the browse category to determine an ordering of the items. For example, in response to receiving a request to view a browse category corresponding to computer products, the ranking engine may determine that the browse category is associated with a third level of the category classification hierarchy. For each item included in the computer products category, the ranking engine can retrieve a shelf importance signal corresponding to the item for the third hierarchy level. A ranked item listing can then be generated based, at least in part, on the retrieved shelf importance signals.

Returning to FIG. 4, the pre-stored shelf importance signals 325 can be accessed by the ranking engine 320 to generate ranked item listings 323 when users 305 submit requests to view browse categories 385 on the electronic platform 330. The ranked item listings 323 can determine an ordering of the items 310 for the browse categories 385, and the GUIs 345 presented to users 305 can display the ranked item listings 323.

In some embodiments, a shelf importance signal 325 for each item can be generated by averaging or normalizing the popularity (based on user engagement activities) across multiple browse categories in a given hierarchy level 381 that are applicable to the item 310. For example, generating a shelf importance signal 325 for a particular hierarchy level 381 can include determining how many browse categories in a given hierarchy level 381 an item is associated with, and analyzing the user engagement data 390 (e.g., the CTR metrics 391, ATCR metrics 392, and OTR metrics 393) corresponding to the item in each of the browse categories 385. A shelf importance signal 325 can then be computed by averaging or normalizing the user engagement values for each of the associated browse categories included in the hierarchy level 381. For each item 310, this process can be applied to compute a separate shelf importance 325 for each hierarchy level 381. During runtime, the shelf importance signals 325 can be retrieved to determine orderings of the items 310 for browse categories that have been selected for viewing by users.

In some scenarios, the shelf importance signals 325 can be combined with one or more of the item popularity signals 321 to compute a final ranking score 322 for each of the items 310 in a given browse category 385 that is requested for viewing. For example, in some embodiments, the ranking score 322 for an item 310 can be computed by combining, or jointly considering: 1) a shelf importance signal 325 indicating an importance of the item 310 with respect to the requested browse category 385; 2) a first item popularity signal 321 that includes a total order metric 394 corresponding to the item; 3) a second item popularity signal 321 that includes a trending metric 395 for the item 310; and 4) a third item popularity signal 321 that includes a global order rate metric 396 corresponding to the item 310. For each item 310 in a requested browse category, these signals can be combined to generate a ranking score 322 for each item, and the ranking score can be used to determine an ordering for the ranked item listing 323 corresponding to the browse category 385.

In some embodiments, the aforementioned signals can be combined using a weighted combination function 371 that applies weights or coefficients to combine the aforementioned signals (e.g., including the shelf importance signal 325 and three item popularity signals 321). In certain embodiments, the weighted combination function 371 can compute a ranking score 322 for an item in a given browse category as follows:

$$rankingScore = 0.00453 * firstItemPopularitySignal + 0.0015 * secondItemPopularitySignal + 0.0015 * thirdItemPopularitySignal + 2. * shelfImportanceSignal$$

where:
firstItemPopularitySignal represents an item popularity signal that includes a total order metric for the item;
secondItemPopularitySignal represents an item popularity signal that includes a trending metric for the item;
thirdItemPopularitySignal represents an item popularity signal that includes a global ordering rate metric for item; and
shelfImportanceSignal represents an shelf importance signal for the item based on a hierarchy level associated with the browse category.

In some embodiments, a weight determination component 370 can execute a function that determines the weights to be applied to each of the above signals. The weight determination component 370 can determine the weights in a pre-processing step, and the weights can be accessed during runtime.

In certain embodiments, the weight determination component 370 includes a linear learning model 375 that is trained using a machine learning framework to optimize the weights for each of the signals. In some cases, the linear learning model 375 can select the weights in a manner that optimizes user engagement. In certain embodiments, a learning to rank (LETOR) framework can be utilized to train the linear learning model 375.

Further details on exemplary techniques for computing the shelf importance signals 325 and generating the weights for the weight combination function 371 are described below.

As mentioned above, the natural tree structure of category classification hierarchy 380 can be leveraged to generate the shelf importance signals 325 in some embodiments. In such embodiments, the shelf importance signals 325 can be represent as a (shelf level, item)-level signal f_{shelf level}(item). For an item i on shelf s with shelf level as l, if item i only belongs to this shelf at level I, then there is no information loss by indexing g_{shelf level l}(item i):=f_{shelf s}(item i) compared to indexing f_{shelf level l}(item i). Motivated by this observation, g_{shelf level l}(item i)==Σw_{s,i} f_{shelf s}(item i) can be defined, such that w_{s,i} measures the importance of shelf s to item i w.r.t. shelf level l in this calculation. Defining the shelf importance signals 325 in this approach significantly reduces the number of shelf importance signals 325 computed for the items 310 (in comparison to the naïve approach mentioned above), thus making it feasible to compute the shelf importance signals 325 in a reasonable timeframe.

In certain embodiments, the (shelf level, item) signals (corresponding to the shelf importance signals 325) can be defined as the traffic-weighted average of the (shelf, item)-level engagement signal. Specifically, for each shelf level I and item i, the shelf importance signals 325 can be computed as follows:

$${g}_{shelf level l} ( item i ) := \sum {w}_{s , i} {f}_{shelf s} ( item i )$$

where:
w_{s,i} is the traffic % normalized by level:

$${w}_{s , i} = \frac{{t}_{s , i}}{{\sum }_{s ∈ ℒ ( l )} {t}_{s , i}} ;$$

t_{s,i} is the browse traffic corresponding to shelf s and item i;
[symbol] (l) is the set of all level-l browse shelves;

In the above formulation, f_{shelf s}(item i) can be estimated by combining (shelf, item)-level customer feedback signals (e.g., corresponding to the CTR metric 391, ATCR metric 392 and OTR signals). Each signal can be computed with a Bayesian approach using a hierarchy level prior estimated using method of moments.

With respect to generating the user engagement metrics 390, let q→shelf_id and i→item_id. Then, the CTR(q, i) for a (shelf_id, item_id) pair can be defined as follows. Suppose there is a random variable C which takes values in {0, 1} as follows: C=1 if an examine resulted in a click event; otherwise, it is 0.

$$CTR ( q , i ) = E [ C ] \qquad ATCR ( q , i ) = E [ A ] \qquad OTR ( q , i ) = E [ 0 ]$$

The user engagement metrics 390 (e.g., the CTR metrics 391, ATCR metrics 392, and OTR metrics 393) can be determined or estimated by examining analyzing the number of examine events, click events, add-to cart (ATC) events, and order placement events for a (q, i) pair. In some cases, a using a Beta-Binomial conjugate Bayesian model can be used. For example, click generation can be modeled as a Binomial process where every examine event is a trial and a click is considered a success, and a Beta distribution can be used to model the prior values for CTR(q, i). Under this framework, the posterior is also a Beta distribution:

$$Beta ( \#clicks + {alpha}_{c} , \#examines - \#clicks + {beta}_{c} ) ∝ Bin ( \#examines , \frac{\#clicks}{\#examines} ) Beta ( {alpha}_{c} , {beta}_{c} ) Beta ( \#atcs + {alpha}_{a} , \#examines - \#atcs + {beta}_{a} ) ∝ Bin ( \#examines , \frac{\#atcs}{\#examines} ) Beta ( {alpha}_{a} , {beta}_{a} ) Beta ( \#orders + {alpha}_{o} , \#examines - \#orders + {beta}_{o} ) ∝ Bin ( \#examines , \frac{\#orders}{\#examines} ) Beta ( {alpha}_{o} , {beta}_{o} )$$

The metric values can be estimated as the mean of the posterior distribution:

$$\begin{matrix}( q , i ) = \frac{\#clicks + {alpha}_{c}}{\#examines + {alpha}_{c} + {beta}_{c}} \\ ( q , i ) = \frac{\#atcs + {alpha}_{a}}{\#examines + {alpha}_{a} + {beta}_{a}} \\ ( q , i ) = \frac{\#orders + {alpha}_{o}}{\#examines + {alpha}_{o} + {beta}_{o}}\end{matrix}$$

Two additional pieces of information can be used to compute the final values: a) evidence in the form of customer engagement (#clicks, #atcs, . . . ); and b) prior signal values (alpha_c, beta_c, etc.). In some scenarios, a year of historical engagement data can be used for the above signal computations, and a method of moments approach can be used to estimate hierarchy level priors.

The beta distribution method of moments can provide the following estimate for the parameters:

$$\begin{matrix}α = ( \frac{1 - μ}{{σ}^{2}} - \frac{1}{μ} ) {μ}^{2} \\ β = α ( \frac{1}{μ} - 1 )\end{matrix}$$

In some scenarios, the year of historical user engagement data 390 can be used to estimate hierarchy level priors corresponding to the CTR metrics 391, ATCR metrics 392, and OTR metrics 393. Additionally, in some cases, the CTR metrics 391, ATCR metrics 392, and OTR metrics 393 for each (shelf_id, item_id) pair can be computed by only considering pairs with #examines>=1000. Then, the average and variance of the CTR metrics 391, ATCR metrics 392, and OTR metrics 393 by brose category 385 can be computed and used in the above equations. This provides the prior weights (alpha_c, beta_c, alpha_a, beta_a, alpha_o, beta_o) for each browse category.

Further, the CTR metrics 391, ATCR metrics 392, and OTR metrics 393 can be combined using a linear learning model 375 to generate the (shelf, item) engagement signal. Weights for the linear learning model 375 can be learned using a list-wise learning to rank (LETOR) setup to predict future engagement using the CTR metrics 391, ATCR metrics 392, and OTR metrics 393 output from the Bayesian framework. The linear learning model 375 can be trained with labeled training data that is generated using future engagement data (e.g., 2 weeks into the future):

$$\begin{matrix}w ( q , {s}_{i} ) = round ( 1 + bin\_weight * {0.9}^{rank ,} ) \\ bin\_weight = \{ \begin{matrix}16 & if orders ( q , {s}_{i} ) > 0 \\ 8 & if orders ( q , {s}_{i} ) = 0 , atcs ( q , {s}_{i} ) > 0 \\ 2 & if orders ( q , {s}_{i} ) = 0 , atcs ( q , {s}_{i} ) = 0 , clicks ( q , {s}_{i} ) > 0 \\ 1 & otherwise\end{matrix}\end{matrix}$$

In some embodiments, rank_i is based on OTR>ATCR>CTR with beta 5-percentile correction.

Other techniques also can be utilized to generate the shelf importance signals 325 described herein.

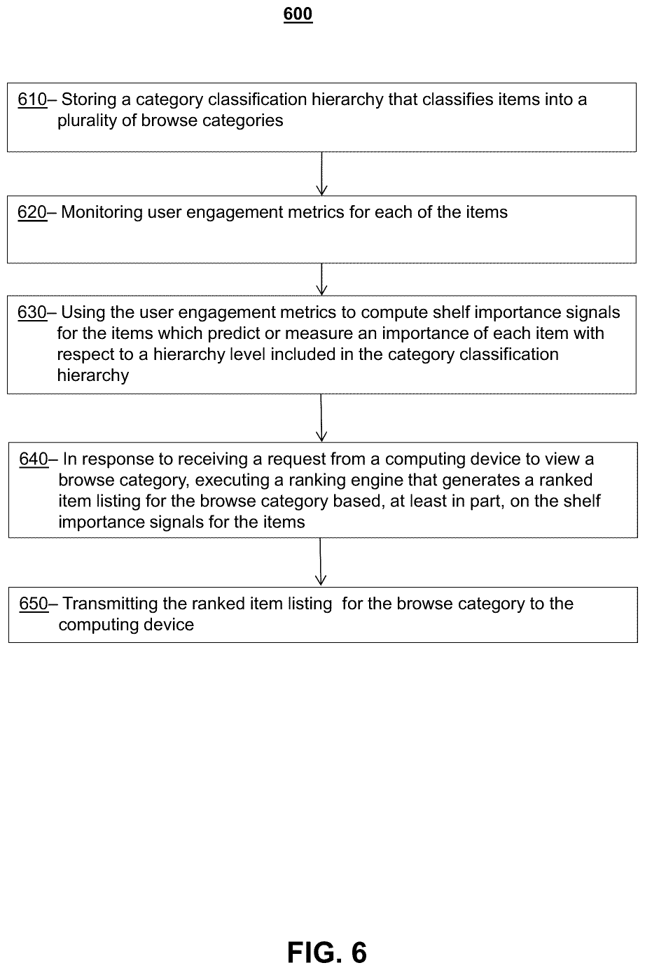

FIG. 6 illustrates a flow chart of a method 600 for generating a ranked item listing for a browse category according to an embodiment. Method 600 is merely exemplary and is not limited to the embodiments presented herein. Method 600 can be employed in many different embodiments or examples not specifically depicted or described herein. In some embodiments, the steps of method 600 can be performed in the order presented. In other embodiments, the steps of method 600 can be performed in any suitable order. In still other embodiments, one or more of the steps of method 600 can be combined or skipped. In many embodiments, system 300 (FIG. 3) can be suitable to perform method 600 and/or one or more of the steps of method 600. In these or other embodiments, one or more of the steps of method 600 can be implemented as one or more computer instructions configured to run at one or more processing modules and configured to be stored at one or more non-transitory memory storage modules. Such non-transitory memory storage modules can be part of a computer system such as system 300 (FIGS. 3-4), web server 301 (FIG. 3), search engine 320 (FIGS. 3-4), and/or electronic platform 330 (FIGS. 3-4). The processing module(s) can be similar or identical to the processing module(s) described above with respect to computer system 100 (FIG. 1).

In step 610 of method 600, a category classification hierarchy is stored that classifies items into a plurality of browse categories. As described above, the category classification hierarchy can include a plurality of hierarchy levels and each of the browse categories can be associated with at least one of the hierarchy levels.

In a subsequent step, step 620 of method 600, user engagement metrics are monitored for each of the items.

Then, in step 630 of method 600, the user engagement metrics are utilized to compute shelf importance signals for the items which predict or measure an importance of each item with respect to a hierarchy level included in the category classification hierarchy.

Afterwards, in step 640 of method 600, in response to receiving a request from a computing device to view a browse category, a ranking engine is executed that generates a ranked item listing for the browse category based, at least in part, on the shelf importance signals for the items.

Later, in step 650 of method 600, the ranked item listing for the browse category is transmitted to the computing device.

The embodiments described herein disclose, among other things, systems and methods for incorporating shelf-level and/or item-level signals into full-text search engines to better support product ranking on browse shelves or browse categories by leveraging the browse tree hierarchy to develop signals at the shelf-level and/or item-level to reduce the quantity of signals needed from many tens of thousands to less than a dozen or so, thus making the implementation in full-text search engines feasible. In some embodiments, a Bayesian approach has been described to create shelf-level and/or item-level engagement signals so that new items have a better chance of being exposed to customers. In the same or different embodiments, machine learned boosting weights are used for baseline ranking in the full-text search engine. As an example, a learning-to-rank framework trained to improve customer engagement learns the weights for three item-level signals and the shelf-level and/or item-level signal used in the baseline ranking, where the weights being obtained from a machine-learned technique are more robust and attuned to improving customer engagement (as compared to ad-hoc weights).

In many embodiments, the techniques described herein can provide a practical application and several technological improvements. In some embodiments, the techniques described herein can provide for ranking items in large-scale electronic platforms that display items in browse categories. The techniques described herein can provide a significant improvement over conventional approaches for ranking items in browse categories purely based on item popularity metrics. Moreover, these estimates are improvements over other possible approaches, such as naïve approaches that may generate separate shelf importance signals for each item-browse category pair. In many embodiments, the techniques described herein can advantageously generate the shelf importance signals in manner that is computationally feasible for large-scale electronic platforms.

In a number of embodiments, the techniques described herein can improve user experiences on electronic platforms by ranking and presenting items in browse categories based on the importance or popularity of the items to the browse categories.

In many embodiments, the techniques described herein can be used continuously at a scale that cannot be reasonably performed using manual techniques or the human mind. For example, an electronic platform can include millions of items, and multiple shelf importance signals can be generated for each item.

In a number of embodiments, the techniques described herein can solve a technical problem that arises only within the realm of computers, as machine learning (e.g., the learning associated with the linear learning models described herein) does not exist outside the realm of computer networks.

Although systems and methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 6 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processors; and
one or more non-transitory computer-readable storage devices storing computing instructions that, when run on the one or more processors, cause the one or more processors to execute functions comprising:
storing a category classification hierarchy that classifies items into a plurality of browse categories, the category classification hierarchy comprising a plurality of hierarchy levels and each of the plurality of browse categories is associated with at least one of the hierarchy levels;
monitoring user engagement metrics for each of the items;
using the user engagement metrics to compute shelf importance signals for the items, each of which predicts or measures an importance of an item with respect to a hierarchy level in the category classification hierarchy;
in response to receiving a request from a computing device to view a browse category, executing a ranking engine to generate a ranked item listing for the browse category based, at least in part, on the shelf importance signals for the items; and
transmitting the ranked item listing for the browse category to the computing device.

2. The system of claim 1, wherein executing the ranking engine to generate the ranked item listing for the browse category includes:
generating one or more item popularity signals for the items included in the browse category; and
utilizing both the shelf importance signals for the items included in the browse category and the one or more item popularity signals for the items included in the browse category to determine an ordering for the ranked item listing.

3. The system of claim 2, wherein the one or more item popularity signals include total order metrics, trending metrics, and global ordering rate metrics pertaining to each of the items included in the browse category.

4. The system of claim 2, wherein:
the ranking engine computes ranking scores for the items included in the browse category based, at least in part, on the one or more item popularity signals for the items included in the browse category and the shelf importance signals for the items included in the browse category; and
the ranking scores are utilized to order the items included in the ranked item listing for the browse category.

5. The system of claim 4, wherein the ranking scores for the items included in the browse category are computed using a weighted combination function that applies weights to the one or more item popularity signals and the shelf importance signals.

6. The system of claim 5, wherein a weight determination function includes a linear learning model that is trained to compute the weights for the weighted combination function.

7. The system of claim 1, wherein using the user engagement metrics to compute the shelf importance signals for the items includes:
for each hierarchy level included in the category classification hierarchy, analyzing the user engagement metrics for the items in each of the plurality of browse categories associated with a corresponding hierarchy level to compute the shelf importance signals.

8. The system of claim 1, wherein the user engagement metrics utilized to compute the shelf importance signals include: click through rate metrics; add-to-cart rate metrics;
and order through rate metrics.

9. The system of claim 1, wherein the shelf importance signals are computed offline in a pre-processing operation.

10. The system of claim 9, wherein the ranking engine retrieves the shelf importance signals in response to receiving the request to view the browse category.

11. A method implemented via execution of computing instructions by one or more processors and stored on one or more non-transitory computer-readable storage devices, the method comprising:
storing a category classification hierarchy that classifies items into a plurality of browse categories, the category classification hierarchy comprising a plurality of hierarchy levels and each of the plurality of browse categories is associated with at least one of the hierarchy levels;
monitoring user engagement metrics for each of the items;
using the user engagement metrics to compute shelf importance signals for the items, each of which predicts or measures an importance of an item with respect to a hierarchy level in the category classification hierarchy;
in response to receiving a request from a computing device to view a browse category, executing a ranking engine to generate a ranked item listing for the browse category based, at least in part, on the shelf importance signals for the items; and
transmitting the ranked item listing for the browse category to the computing device.

12. The method of claim 11, wherein executing the ranking engine to generate the ranked item listing for the browse category includes:
generating one or more item popularity signals for the items included in the browse category; and
utilizing both the shelf importance signals for the items included in the browse category and the one or more item popularity signals for the items included in the browse category to determine an ordering for the ranked item listing.

13. The method of claim 12, wherein the one or more item popularity signals include total order metrics, trending metrics, and global ordering rate metrics pertaining to each of the items included in the browse category.

14. The method of claim 12, wherein:
the ranking engine computes ranking scores for the items included in the browse category based, at least in part, on the one or more item popularity signals for the items included in the browse category and the shelf importance signals for the items included in the browse category; and
the ranking scores are utilized to order the items included in the ranked item listing for the browse category.

15. The method of claim 14, wherein the ranking scores for the items included in the browse category are computed using a weighted combination function that applies weights to the one or more item popularity signals and the shelf importance signals.

16. The method of claim 15, wherein a weight determination function includes a linear learning model that is trained to compute the weights for the weighted combination function.

17. The method of claim 11, wherein using the user engagement metrics to compute the shelf importance signals for the items includes:
for each hierarchy level included in the category classification hierarchy, analyzing the user engagement metrics for the items in each of the plurality of browse categories associated with a corresponding hierarchy level to compute the shelf importance signals.

18. The method of claim 11, wherein the user engagement metrics utilized to compute the shelf importance signals include: click through rate metrics; add-to-cart rate metrics; and order through rate metrics.

19. The method of claim 11, wherein the shelf importance signals are computed offline in a pre-processing operation.

20. The method of claim 19, wherein the ranking engine retrieves the shelf importance signals in response to receiving the request to view the browse category.
